(19) United States
(12) Patent Application Publication
(10) Pub. No.: US 2021/0072436 A1
(43) Pub. Date: Mar. 11, 2021

(54) STRUCTURED RETROREFLECTIVE ARTICLE WITH ALIGNED SYMBOLS

(71) Applicant: 3M INNOVATIVE PROPERTIES COMPANY, St. Paul, MN (US)

(72) Inventors: Todd D. JONES, St. Paul, MN (US); Kui CHEN-HO, Woodbury, MN (US)

(21) Appl. No.: 16/958,185

(22) PCT Filed: Dec. 20, 2018
(86) PCT No.: PCT/IB2018/060475

§ 371 Date: Jun. 26, 2020

Related U.S. Application Data
(60) Provisional application No. 62/611,633, filed on Dec. 29, 2017.

(51) Int. Cl. G02B 5/12; B29D 11/00

(52) U.S. Cl. CPC G02B 5/12; B29D 11/00605

(57) ABSTRACT

The disclosed structured retroreflective article includes a symbol aligned with raised regions of the structured retroreflective article through an orientation mark which aligns the symbol to the raised region. In one embodiment, the retroreflective article comprises a substrate comprising a background surface and a raised region, a retroreflective film comprising a first symbol and an orientation mark, wherein the retroreflective film is applied to the substrate and the orientation mark aligns the first symbol to the raised region.

### FIELD

The present disclosure relates to a structured retroreflective article with aligned symbols.

### BACKGROUND

Retroreflective films are used on articles such as signs, license plates, or wearable items. The retroreflective film illuminates the article when a light is directed at the article. The retroreflective article might include markings that need to be read and interpreted. The illumination of the retroreflective film can aid in readability of the markings on the article. Some articles require that the marking are placed on raised regions of the article. Typically, the article with the attached retroreflective film is provided with raised regions and then paint is applied to those raised portions.

### SUMMARY

The disclosed structured retroreflective article includes a symbol aligned with raised regions of the structured retroreflective article through an orientation mark which aligns the symbol to the raised region. In one embodiment, the retroreflective article comprises a substrate comprising a background surface and a raised region, a retroreflective film comprising a first symbol and an orientation mark, wherein the retroreflective film is applied to the substrate and the orientation mark aligns the first symbol to the raised region.

In one embodiment, the retroreflective film further comprises a second symbol. In one embodiment, the second symbol is contained within the boundaries of the first symbol. In one embodiment, the second symbol is contained entirely within the boundaries of the first symbol. In one embodiment, the first symbol comprises human-readable information and the second symbol comprises embedded machine-readable information. In one embodiment, the first symbol comprises human-readable information detectable under a first condition and not detectable under a second condition and the second symbol comprises embedded machine-readable information not detectable under the first condition and detectable under the second condition. In one embodiment, the first condition is a first spectral range or first lighting condition and the second condition is a second spectral range or second lighting condition, different from the first condition. In one embodiment, the second symbol comprises embedded machine-readable information including at least one embedded-marker comprising a gap and a solid portion, wherein the gap and solid portion in combination correspond to the human-readable information.

In one embodiment, the orientation mark is on a surface of the retroreflective film containing the first symbol. In one embodiment, the orientation mark is on a surface of the retroreflective film opposite from the first symbol. In one embodiment, the orientation mark is apparent in the visible light spectrum. In one embodiment, the orientation mark is not detectable in the visible light spectrum and apparent outside the visible light spectrum. In one embodiment, the orientation mark is not detectable in the visible light spectrum and apparent in the infrared light spectrum. In one embodiment, the orientation mark is a defined pattern of visible light returned from the retroreflective film. In one embodiment, the retroreflective film comprises optically active regions for returning light, and wherein the optically active regions are in a defined pattern to form the orientation mark.

In one embodiment, the first symbol is a unique identifier. In one embodiment, the first symbol is an alpha numeric character. In one embodiment, the first symbol is in contrast with the background adjacent to the first symbol.

In one embodiment, the retroreflective article further comprises a protective film wherein the first symbol is between the retroreflective film and the protective film.

In one embodiment, the method of making a retroreflective article comprises printing a retroreflective film with a first symbol, wherein the retroreflective film includes an orientation mark at a location relative to the first symbol, applying the retroreflective film to a substrate with the orientation marks in an aligned location on the substrate, and forming raised regions in the substrate and applied retroreflective film that align with the first symbol.

In one embodiment, the method further comprises visually identifying the orientation mark. In one embodiment, visually identifying the orientation mark uses visible light. In one embodiment, visually identifying the orientation mark uses infrared light.

In one embodiment, the first symbol is a unique identifier that corresponds to the raised regions.

In one embodiment, the method further comprises applying the orientation mark to the retroreflective film before applying the retroreflective film to the substrate. In one embodiment, the method further comprises forming a pattern of an optically active region as the orientation mark in the retroreflective film before applying the retroreflective film to the substrate. In one embodiment, the method further comprises printing a pattern of barrier elements on an adhesive before applying the retroreflective film to the substrate, wherein the printed barrier elements form the orientation mark and applying the adhesive with barrier elements to optical elements on the retroreflective film, wherein the adhesive is in contact with the optical elements. In one embodiment, the method further comprises printing a pattern of barrier elements on an adhesive before applying the retroreflective film to the substrate and applying the adhesive with barrier elements to optical elements on the retroreflective film, wherein the adhesive is in contact with the optical elements and wherein the adhesive forms orientation mark.

In one embodiment, the method further comprises applying a protective layer to the retroreflective article over the first symbol before forming raised regions in the substrate.

In one embodiment, the method further comprises printing a retroreflective film with a second symbol. In one embodiment, the second symbol is contained within the boundaries of the first symbol. In one embodiment, the second symbol is contained entirely within the boundaries of the first symbol.

### BRIEF DESCRIPTION OF THE DRAWINGS

FIG. 1 is a front view of one embodiment of a retroreflective article;

FIG. 2 is a cross-sectional view of the retroreflective article through line 2-2 of FIG. 1;

FIG. 3 is a rear view of one embodiment of a retroreflective article;

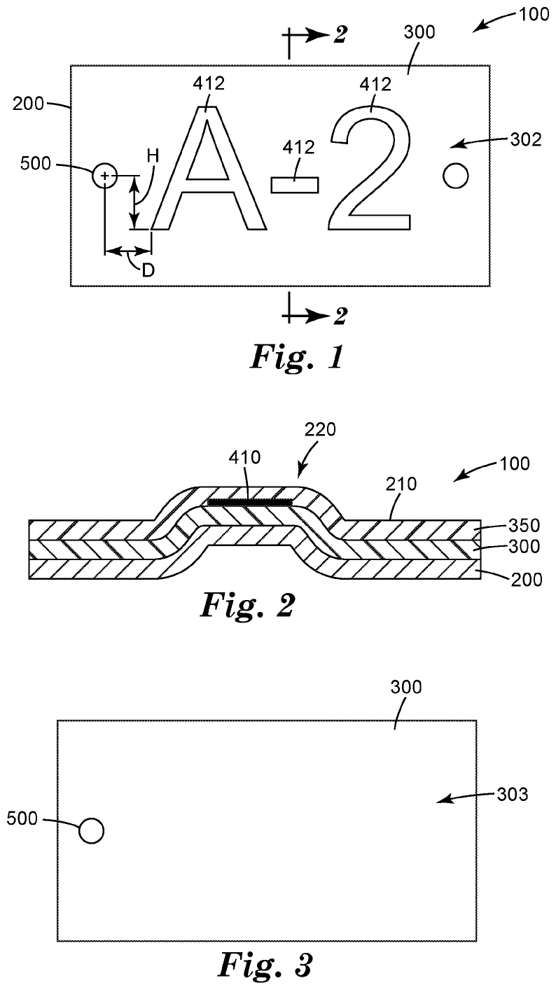

FIG. 2 is a front view of the retroreflective article of FIG. 1 in a second lighting condition;

FIG. 5 is a cross-sectional view of one embodiment of a retroreflective sheeting;

FIG. 6 is a side view of one embodiment of a method of making a retroreflective article.

### DETAILED DESCRIPTION

FIG. 1 is a front view of one embodiment of a retroreflective article 100 with a raised first symbol 410. FIG. 2 is a cross-section view of the retroreflective article 100 through line 2-2 of FIG. 1 depicting the raised symbol 410. As shown in FIGS. 1 and 2, the first symbol 410 corresponds to the raised regions on the substrate 200.

The disclosed retroreflective article 100 comprises a substrate 200 and a retroreflective film 300 applied to the substrate 200. The substrate 200 typically is flat and then contoured through a process such as embossing to have a background surface 210 and a raised region 220. The substrate 200 may be formed of any material having the desired rigidity and conformity for forming raised regions 220. For example, the substrate 200 may be metal, plastic, or composite materials.

As shown in FIG. 1, retroreflective film comprises at least a first symbol 410 that is aligned with the raised region 220 and an orientation mark 500. The first symbol 410 displays visual information. The first symbol 410 may be an individual or set of letters, numbers, shapes or combinations thereof. In one embodiment, the first symbol is a unique identifier.

First symbol 410 may be read from the contrast between the first symbol 410 and adjacent portion of the retroreflective film 300 without the first symbol 410. Raising the first symbol 410 relative to the background surface 210 can increase the visibility of the first symbol 410 relative to the background surface 210, unraised portion, of the retroreflective article 100.

The first symbol 410 may be human readable, machine readable, or both. The first symbol 410 may be human readable under a first lighting condition, and human readable under a second lighting condition, which is different from the first lighting condition. The first symbol 410 may be machine readable under a first lighting condition, and machine readable under a second lighting condition, which is different from the first lighting condition. First and second light conditions may include lighting under diffuse light, directional light, retroreflected light, polarized light (circularly polarized or linearly polarized light), light under different wavelength, for example visible or infrared light.

In convention processes, paint is applied to the raised portions of a plate after the retroreflective sheeting is applied to the plate and after the raised regions are included on the plate. In an embodiment of the disclosed retroreflective article 100, the retroreflective film 300 can include the symbol 410 prior to the retroreflective film 300 being placed on the substrate 200 and prior to the substrate 200 having raised regions 220. Orientation mark 500 is included at a defined location relative to the first symbol 410 to provide orientation of the first symbol 410 to a location on the substrate 200 where the raised region 220 will be formed.

As shown in FIG. 1, orientation mark 500 is located on a first surface 302 of the retroreflective film 300, which also contains the first symbol 410. The orientation mark 500 is on the retroreflective sheeting 300 at a defined location relative to the first symbol 410 so that the first symbol 410 can be aligned to the area that will be the raised region 220 of the substrate 200. For example, as shown in FIG. 1, a center of the orientation mark 500 is located at a distance “D” from a lowermost, left end of the first symbol 410, and at a height “H” from that same lowermost, left end of the first symbol 410. The orientation mark 500 is used to apply the retroreflective sheeting 300 relative to a known location on the substrate 200. It is understood that any number of ways to determine and define the location of the orientation mark 500 relative to the first symbol 410 can be used. For example, the location on the substrate 200 providing the reference to the orientation mark 500 could be an edge, a corner, or a pre-marked portion of the substrate 200.

The orientation mark 500 is visually apparent under a light condition. The light conditions may include diffuse light, directional light, retroreflected light, polarized light (circularly polarized or linearly polarized light), light under different wavelength, for example visible or infrared light. In one embodiment, the orientation mark 500 is apparent under diffuse light or retroreflected light or both. In one embodiment, the orientation mark 500 is apparent under light in the visible light spectrum or outside the visible light spectrum, or both. In one embodiment, to make the orientation mark 500 less conspicuous to the human eye, the orientation mark 500 is only apparent outside the visible light spectrum, such as by infrared light.

The orientation mark 500 could be formed from printing on the retroreflective film 300. The print could be visibly apparent inks, visibly transparent but apparent outside the visible light range, such as infrared visible, or could be a retarder ink. Therefore, a printed orientation mark 500 could be apparent to a human eye, a camera (visible camera, or IR reading cameras, for example), or both. The contrast between the orientation mark 500 and the adjacent area on the retroreflective film 300 makes the orientation mark 500 apparent.

The orientation mark 500 could be formed as a region of the retroreflective film 300 that returns light, an active region, in a manner that is different, and distinguishable from the retroreflective film 300 at the background surface 210. For example, the retroreflective film 300 may return light in a defined pattern at the active region. Therefore, when a light source directs light onto the retroreflective film 330, a visibly apparent bright spot, pattern, or shape (i.e., retroreflected light) at the active region is distinguishable as the orientation mark 500. With reference to FIG. 5, barrier elements 324 could be applied in a size, shape, or arrangement to provide an active regions forming the orientation mark 500. For other arrangements of retroreflective films, selective placement of the optically active areas can form the orientation mark 500.

The orientation mark 500 could be formed as region of the retroreflective film 300 that does not return light, an inactive region, in a manner that is different, and distinguishable for the retroreflective film 300 at the background surface 210. Therefore, when a light source directs light onto the retroreflective film 330, a visibly apparent dark spot (i.e., no light return) at the active region is distinguishable for the orientation mark 500. With reference to FIG. 5, adhesive 340 could be applied in a size, shape, or arrangement to provide an inactive regions forming the orientation mark 500. For other arrangements of retroreflective films, selective placement the optically inactive areas can form the orientation mark 500.

The orientation mark 500 could be formed by using a retarder with a phase-reversing reflector when viewing with a corresponding transceiver systems, such as disclosed in U.S. Patent Application 62/578,191 filed on Oct. 27, 2017 (attorney docket number 80109US002). For example, the orientation mark could be the portion comprising the retarder. Alternatively, the substrate 200 could include a retarder with the portion for the orientation mark not having the retarder. For example, the retarder could be a film or a printed liquid crystal.

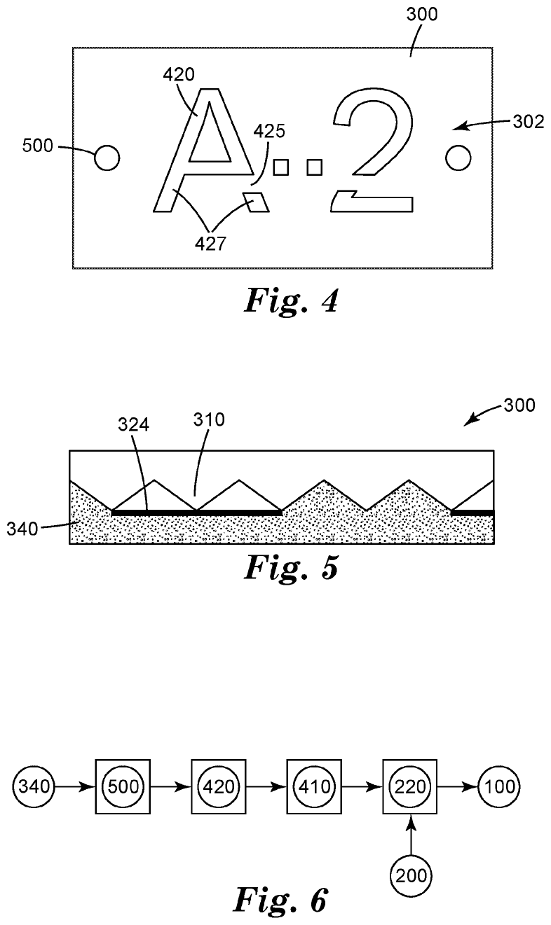

As shown in FIG. 3, the orientation mark 500, such as described above, could be on a second surface 303 of the retroreflective sheeting 300, which is the surface opposite from the first surface 302 that contains the first symbol 300.

In one embodiment, a second symbol 420 is applied to the retroreflective sheeting 300. FIG. 4, shows the second symbol 420 within the retroreflective sheeting 300 of FIG. 1. As shown in this embodiment, the second symbol 420 is contained within the boundaries of the first symbol 410, and specifically is contained entirely within the boundaries of the first symbol 410. Use of a first and second symbol is described in more detail in PCT Publications WO2013/149142 and WO2017/034968, the disclosures of which are herein incorporated by reference.

In one embodiment, the first symbol 410 comprises human-readable information and the second symbol 420 comprises embedded machine-readable information. In one embodiment, the first symbol 410 comprises human-readable information detectable under a first condition and not detectable under a second condition and the second symbol 420 comprises embedded machine-readable information not detectable under the first condition and detectable under the second condition. The first condition may be, for example, a first spectral range or first lighting condition and the second condition may be a second spectral range or second lighting condition, different from the first condition.

In one embodiment, as shown in FIG. 4, the second symbol 420 comprises embedded machine-readable information including at least one embedded-marker comprising a gap 425 and a solid portion 427, wherein the gap 425 and solid portion 427 in combination correspond to the human-readable information in the first symbol 410. It is understood that various configurations of machine readable information, e.g. bar codes, QR codes, or any arrangement that can provide a code could use used.

FIG. 5 discloses one embodiment of a retroreflective film 300. The retroreflective film 300 shown in FIG. 5 comprises optical elements 310, an adhesive layer 340, and barrier elements 324 applied to the adhesive layer 340. Portions of the adhesive layer 340 contact the optical elements 310, which form optically inactive portions that do not substantially retroreflect incoming light, and portion of the adhesive layer 340 containing the barrier elements 324 form pockets of air adjacent to the optical elements 310, which form optically active portions that retroreflect incoming light. For example, U.S. Patent Application Publication 2013/0034682, incorporated herein by reference discloses a retroreflective film with an adhesive layer and barrier elements.

The retroreflective film 300 can be any number of retroreflective materials used to return light to a light source. Retroreflective films comprise optical elements for returning the incoming light. For example, optical elements could be glass or ceramic beads with an adjacent reflecting layer, such as a metalized layer or a dielectric stack to cause the incoming light to retroreflect, such as shown in U.S. Pat. No. 9,110,235, incorporated herein by reference. For example, optical elements can be microstructures with a cube corner to return light. Microstructures could be, for example any number of shapes such as truncated cubes or full cubes. A reflecting layer may be adjacent to the microstructure, or a material of significantly different refractive index to the material of the microstructure can be adjacent to the microstructure to cause the incoming light to retroreflect. Commonly, air is adjacent to the microstructure. U.S. Pat. No. 8,371,703, incorporated herein by reference discloses a truncated cube retroreflective film. U.S. Pat. No. 7,156,527, incorporated herein by reference discloses a full cube retroreflective film.

The retroreflective film might include a sealing layer with portions of the sealing layer contacting the microstructures, which form optically inactive portions, and portion of the sealing layer forming pockets of air adjacent to the microstructures, which form optically active portions. For example, U.S. Pat. No. 9,366,789, incorporated herein by reference discloses a retroreflective film with a sealing layer.

The retroreflective article 100 may further comprise a protective film 350, like shown in FIG. 2. Typically, the first symbol 410 (and second symbol if included) is between the retroreflective film 300 and the protective film 350. The retroreflective film 300 may include an adhesive for securing the retroreflective film to the substrate 200.

FIG. 6 is a side view of a process for making retroreflective article 100. In this process, orientation mark 500 is formed in the retroreflective sheeting 300. As described above, this could be a printing process applied to a surface of a retroreflective film 300. In another embodiment, the orientation mark 500 could be formed during the creation of the retroreflective film 300, if the orientation mark 500 is either an optically active or optically inactive area of the retroreflective film 300. For example, a specific pattern of barrier elements could be plated at determined locations of the retroreflective film 300.

The second symbol 420, if included, is applied, and then the overlying first symbol 410 is applied. In some embodiments, the second symbol 420 may be placed overlying the first symbol 410. A sensor, such as a camera, is used to locate the orientation mark 500 to inform a system for placement of the first symbol 410 (and second symbol 420, if included) at a location relative to the orientation mark 500. This sensor may rely on visible light, light outside visible like infrared, directional light, polarized light, retroreflected light, or diffuse light to identify the orientation mark 500.

If the orientation mark 500 is an applied marking, such as printing, then the first symbol 410 and second symbol 420, if included, could be applied to the retroreflective film 300 first and then the orientation mark 500 can be placed on the retroreflective film 300 as a determined location relative to the first symbol 410 or second symbol 420. The retroreflective film 300 containing the orientation mark 500, first symbol 410, and second symbol 420, if included, is then applied to the substrate 200, which is pressed to formed raised regions 220. A sensor, such as a camera, is used to locate the orientation mark 500 and inform a system for placement of the first symbol 410 and second symbol 420, if included, to the location of the raised regions 220. This sensor may rely on visible light, light outside visible like infrared, directional light, polarized light, retroreflected light, or diffuse light to identify the orientation mark 500.

In one embodiment, the orientation mark 500 is an arrangement of either the adhesive 340 or barrier element 324 (FIG. 5), to form either optically inactive regions or optically active regions, respectively. Therefore, in FIG. 1, the orientation mark 500 is formed within the retroreflective film 300. A pattern of barrier elements is printed on an adhesive before applying the retroreflective film 300 to the substrate 200.

A protective layer 350 is applied after the symbols 410, 420 are formed on the retroreflective article 300. In one embodiment, the protective layer is applied prior to the raised regions 220 being formed in the substrate 200.

The disclosed retroreflective article supports a method of forming onto the retroreflective film symbols prior to the film application to the substrate and prior to the substrate having the raised regions.

Therefore, the symbols on a retroreflective film can be produced on a continuously extending sheet of retroreflective film. This could achieve manufacturing efficiencies or security around unique identifiers on for each retroreflective article. Further, this allows for first and second symbols to be easily included onto the retroreflective film as compared to conventional techniques, which apply a paint to already-formed raised regions. Conventional techniques would not easily allow for multilayer materials to be included when the symbols are applied after formation of the raised regions.

Although specific embodiments have been shown and described herein, it is understood that these embodiments are merely illustrative of many possible arrangements. Numerous and varied other arrangements can be devised by those of skill in the art without departing from the spirit and scope of the invention. Thus, the scope of the present invention should not be limited to the structures described in this application, but only by the structures described by the language of the claims and the equivalents of those structures. The figures may not be drawn to scale.

### ILLUSTRATIVE EMBODIMENTS

1. A retroreflective article comprising:
a substrate comprising a background surface and a raised region;
a retroreflective film comprising a first symbol and an orientation mark;
wherein the retroreflective film is applied to the substrate and the orientation mark aligns the first symbol to the raised region.

2. The retroreflective article of any one of the preceding embodiments, wherein the retroreflective film further comprises a second symbol.

3. The retroreflective article of any one of the preceding embodiments, wherein the second symbol is contained within the boundaries of the first symbol.

4. The retroreflective article of any one of the preceding embodiments, wherein the second symbol is contained entirely within the boundaries of the first symbol.

5. The retroreflective article of any one of the preceding embodiments, wherein the first symbol comprises human-readable information and the second symbol comprises embedded machine-readable information.

6. The retroreflective article of any one of the preceding embodiments, wherein the first symbol comprises human-readable information detectable under a first condition and the second symbol comprises embedded machine-readable information detectable under the second condition.

7. The retroreflective article of any one of the preceding embodiments, wherein the first symbol comprises human-readable information detectable under a first condition and not detectable under a second condition and the second symbol comprises embedded machine-readable information not detectable under the first condition and detectable under the second condition.

8. The retroreflective article of any one of the preceding embodiments, wherein the first condition is a first spectral range or first lighting condition and the second condition is a second spectral range or second lighting condition, different from the first condition.

9. The retroreflective article of any one of the preceding embodiments, wherein:
the second symbol comprises embedded machine-readable information including at least one embedded-marker comprising a gap and a solid portion, wherein the gap and solid portion in combination correspond to the human-readable information.

10. The retroreflective article of any one of the preceding embodiments, wherein the orientation mark is on a surface of the retroreflective film containing the first symbol.

11. The retroreflective article of any one of the preceding embodiments, wherein the orientation mark is on a surface of the retroreflective film opposite from the first symbol.

12. The retroreflective article of any one of the preceding embodiments, wherein the orientation mark is apparent in the visible light spectrum.

13. The retroreflective article of any one of the preceding embodiments, wherein the orientation mark is transparent in the visible light spectrum and apparent outside the visible light spectrum.

14. The retroreflective article of any one of the preceding embodiments, wherein the orientation mark is transparent in the visible light spectrum and apparent in the infrared light spectrum.

15. The retroreflective article of any one of the preceding embodiments, wherein the orientation mark is a defined pattern of visible light returned from the retroreflective film.

16. The retroreflective article of any one of the preceding embodiments, wherein retroreflective film comprises optically active regions for returning light, and wherein the optically active regions are in a defined pattern to form the orientation mark.

17. The retroreflective article of any one of the preceding embodiments, wherein the first symbol is a unique identifier.

18. The retroreflective article of any one of the preceding embodiments, wherein the first symbol is an alpha numeric character.

19. The retroreflective article of any one of the preceding embodiments, wherein the first symbol is in contrast with the background adjacent to the first symbol.

20. The retroreflective article of any one of the preceding embodiments, further comprises a protective film wherein the first symbol is between the retroreflective film and the protective film.

21. A method of making a retroreflective article comprising:
applying a first symbol and orientation mark to a retroreflective film, wherein the orientation mark is at a location relative to the first symbol;
applying the retroreflective film to a substrate with the orientation marks in an aligned location on the substrate;
forming raised regions in the substrate and applied retroreflective film that align with the first symbol.

22. The method of making the retroreflective article of embodiment 21, wherein the first symbol is applied to the retroreflective film comprising the orientation mark.

23. The method of making a retroreflective article of any one of embodiments 21-22, further comprising:
visually identifying the orientation mark.

24. The method of making a retroreflective article of embodiment 23, wherein the visually identifying the orientation mark uses one of visible light, infrared light, directional light, polarized light, retroreflected light.

25. The method of making a retroreflective article of any one of embodiments 21-24, wherein the first symbol is a unique identifier that corresponds to the raised regions.

26. The method of making a retroreflective article of any one of embodiments 21-25, comprising:
applying the orientation mark to the retroreflective film before applying the retroreflective film to the substrate.

27. The method of making a retroreflective article of any one of embodiments 21-26, comprising:
forming a pattern of an optically active region as the orientation mark in the retroreflective film before applying the retroreflective film to the substrate.

28. The method of making a retroreflective article of any one of embodiments 21-27, comprising:
printing a pattern of barrier elements on an adhesive before applying the retroreflective film to the substrate, wherein the printed barrier elements form the orientation mark;
applying the adhesive with barrier elements to optical elements on the retroreflective film, wherein the adhesive is in contact with the optical elements.

29. The method of making a retroreflective article of any one of embodiments 21-28, comprising:
printing a pattern of barrier elements on an adhesive before applying the retroreflective film to the substrate;
applying the adhesive with barrier elements to optical elements on the retroreflective film, wherein the adhesive is in contact with the optical elements and wherein the adhesive forms orientation mark.

30. The method of making a retroreflective article of any one of embodiments 21-29, comprising:
applying a protective layer to the retroreflective article over the first symbol before forming raised regions in the substrate.

31. The method of making a retroreflective article of any one of embodiments 21-30, comprising printing a retroreflective film with a second symbol.

32. The method of making a retroreflective article of embodiment 31, wherein the second symbol is contained within the boundaries of the first symbol.

33. The method of making a retroreflective article of embodiment 31, wherein the second symbol is contained entirely within the boundaries of the first symbol.

1. A retroreflective article comprising:
a substrate comprising a background surface and a raised region;
a retroreflective film comprising a first symbol and an orientation mark;
wherein the retroreflective film is applied to the substrate and the orientation mark aligns the first symbol to the raised region.

2. The retroreflective article of claim 1, wherein the retroreflective film further comprises a second symbol.

3. The retroreflective article of claim 1, wherein the second symbol is contained within the boundaries of the first symbol.

4. The retroreflective article of any one of the preceding claims claim 1, wherein the first symbol comprises human-readable information and the second symbol comprises embedded machine-readable information.

5. The retroreflective article of claim 1, wherein the first symbol comprises human-readable information detectable under a first condition and the second symbol comprises embedded machine-readable information detectable under the second condition.

6. The retroreflective article of claim 1, wherein the first symbol comprises human-readable information detectable under a first condition and not detectable under a second condition and the second symbol comprises embedded machine-readable information not detectable under the first condition and detectable under the second condition.

7. The retroreflective article of claim 1, wherein:
the second symbol comprises embedded machine-readable information including at least one embedded-marker comprising a gap and a solid portion, wherein the gap and solid portion in combination correspond to the human-readable information.

8. The retroreflective article of claim 1, wherein the orientation mark is on a surface of the retroreflective film containing the first symbol.

9. The retroreflective article of claim 1, wherein the orientation mark is apparent in the visible light spectrum.

10. The retroreflective article of claim 1, wherein the orientation mark is transparent in the visible light spectrum and apparent outside the visible light spectrum.

11. The retroreflective article of claim 1, wherein retroreflective film comprises optically active regions for returning light, and wherein the optically active regions are in a defined pattern to form the orientation mark.

12. The retroreflective article of claim 1, wherein the first symbol is an alpha numeric character.

13. The retroreflective article of claim 1, wherein the first symbol is in contrast with the background adjacent to the first symbol.

14. The retroreflective article of claim 1, further comprising a protective film wherein the first symbol is between the retroreflective film and the protective film.

15. A method of making a retroreflective article comprising:
applying a first symbol and orientation mark to a retroreflective film, wherein the orientation mark is at a location relative to the first symbol;
applying the retroreflective film to a substrate with the orientation marks in an aligned location on the substrate;
forming raised regions in the substrate and applied retroreflective film that align with the first symbol.

16. The method of making a retroreflective article of claim 0, further comprising:
visually identifying the orientation mark.

17. The method of making a retroreflective article of claim 0, wherein the visually identifying the orientation mark uses one of visible light, infrared light, directional light, polarized light, retroreflected light.

18. The method of making a retroreflective article of claim 15, comprising:
applying the orientation mark to the retroreflective film before applying the retroreflective film to the substrate.

19. The method of making a retroreflective article claim 15, comprising:
printing a pattern of barrier elements on an adhesive before applying the retroreflective film to the substrate, wherein the printed barrier elements form the orientation mark;
applying the adhesive with barrier elements to optical elements on the retroreflective film, wherein the adhesive is in contact with the optical elements.

20. The method of making a retroreflective article of claim 15, comprising printing a retroreflective film with a second symbol.
